(19) United States
(12) Patent Application Publication
(10) Pub. No.: US 2004/0031143 A1
(43) Pub. Date: Feb. 19, 2004

(54) Method of manufacturing metal air cell system

(76) Inventors: William Morris, Yonkers, NY (US); Tsepin Tsai, Chappaqua, NY (US)

Correspondence Address: Reveo, Inc., 85 Executive Blvd., Elmsford, NY, 10523, US

(21) Appl. No.: 10/452,833

(22) Filed: Jun. 2, 2003

Related U.S. Application Data
(60) Provisional application No. 60/384,550, filed on May 31, 2002.

(51) Int. Cl. B29B 13/00

(52) U.S. Cl. 29/623.4; 264/271.1

(57) ABSTRACT

The present invention provides a method of manufacturing metal air cell systems. The method includes a thermoset molding step to integrate the cell structure with necessary cell components. This method offers reliable, stable structure and, most importantly, good bonding with porous components (e.g., air cathode, charging cathode) to prevent potential leakage.

### RELATED APPLICATIONS

The present invention claims priority to U.S. Provisional Patent Application No. 60/384,550 filed on May 31, 2002, which is incorporated by reference herein.

### BACKGROUND OF THE INVENTION

1. Field of the Invention

This invention relates to air diffusion electrodes and cell systems using such electrodes, and particularly to a method of manufacturing air diffusion electrodes and metal air cell systems using air diffusion electrodes.

2. Description of the Prior Art

Electrochemical power sources are devices through which electric energy can be produced by means of electrochemical reactions. These devices include metal air electrochemical cells such as zinc air, aluminum air and magnesium air batteries or fuel cells. Such cells generally use the metal as the negative electrode, and oxygen diffused through an air diffusion electrode as the positive electrode. The air diffusion electrode generally comprises a semipermeable membrane and a catalyzed layer for electrochemical reaction. An electrolyte is provided between the metal electrode and the air diffusion electrode, such as a caustic liquid that is ionic conducting but not electrically conducting.

Metal air electrochemical cells have numerous advantages over traditional hydrogen-based fuel cells. Metal air electrochemical cells have high energy density (W*hr/Liter), high specific energy (W*hr/kg), and run at ambient temperature. The fuel may be solid state, therefore, safe and easy to handle and store.

One of the principle obstacles of metal air electrochemical cells is the prevention of leakage of the electrolyte, typically a liquid electrolyte. For example, in forming metal air cells, it is know to glue cathode portions to a cathode frame. However, caustic electrolyte may destroy this seal, causing electrolyte to leak at the juncture of the cathode and the frame. Further, this glued portion is prone to delaminating after repeated use, for example, in a cell that is designed to have the anode removed and replaced (e.g., in a refuelable configuration).

Solomon U.S. Pat. No. 4,440,617, entitled “Non-bleeding electrode”, discloses non-bleeding gas electrode having an active layer, a backing layer on one side of the active layer, and a current distributor on the other side of the active layer. The pores in the active layer and the backing layer are controlled to relieve hydrodynamic pressures generally by coordinating the pore size such that the repellancy of the backing layer to heated alkali solutions exceeds the internal liquid pressures in the active layer. However, Solomon does not teach how to seal the edges of the gas electrode, a critical source of electrolyte leakage.

Shine et al. U.S. Pat. No. 6,500,575 entitled “In-cell air management” teaches metal-air batteries using spacer sheets with protrusions to form air pathway for the cathodes and micro pumps (fans) to create air draft in the pathway. As disclosed, the spacer sheets can be prepared by screen printing or injection molding of a protrusion pattern from substrates such as polypropylene, polyamide, polyethylene oxide, polyethylene terephthalate, polyacrylamide and polyurethane, of materials such as epoxy, acetal, acrylic and urethane. However, these are formed separately from the air diffusion electrodes, and no protection is provided at the edges thereof.

Dudley et al. U.S. Patent Publication No. 20020197535A1 entitled “Coating edge control” discloses a method of coating a substrate with a cathode material for an electrochemical . Edge material is coated at one or more edges of a substrate, which is at a step fore or aft coated with a cathode material. The edge material is provided to improve a thickness profile at the edges, to reduce detriments associated with tapered cathode material edges, wherein the coating material and the edge material contact each other, and wherein the thickness profile at the edge of the coated cathode material is improved relative to a thickness profile of an edge of a cathode material coated without the edge material. However, such methods are time consuming, in that the air diffusion manufacturing process must be modified to incorporate the edge coated regions.

Smilanich et al. U.S. Pat. No. 4,404,266 entitled “Miniature air cells with seal” discloses button type metal air cells formed with a sealing agent at a ring contacting the air electrode. Such cells are formed in a metallic can structure, thus such a ring is only as a seal, and is not part of a housing structure.

Niksa et al. U.S. Pat. No. 4,950,561 entitled “Metal-air battery with easily removable anodes” discloses a system having mechanically removable anode structures. As described therein, a cathode is fastened to a frame structure by means of a caustic resistant epoxy cement or the like, e.g., a silicon adhesive. Also, a gasket is disclosed, such as neoprene or ethylene-propylene-diene-monomer (EPDM). However, the adhesion is subject to delaminating problems as described heretofore.

One proposed approach to forming a leak resistant cell is with conventional injection molding techniques, that generally rely on thermoplastic materials. However, such methods may not be suitable for the metal air cells. First, caustic resistant injection molding material (e.g., ABS plastic) is prone to shrinkage, which may lead to undesirable cell and/or electrode deformation. Further, high pressures required with injection molding techniques, generally both in the form of clamping pressures to secure the mold, and injection pressures to inject the material. Typical injection molding processes require 10 to 100 M Pa, and even as low as 0.2-0.8 M Pa for specialty ceramic injection molding techniques. Such pressures may adversely affect the components themselves and the arrangement of the loose parts (since many of the parts used are not secured during the molding process). Additionally, injection molding techniques typically require temperatures of at least 200 degrees C., which will substantially detriment the electrodes and certain plastic frame components (e.g., the air frame).

Therefore, a need remains in the art for a metal air cell that is structurally robust and prevents electrolyte leakage, particularly at the air diffusion electrode.

### SUMMARY OF THE INVENTION

The above-discussed and other problems and deficiencies of the prior art are overcome or alleviated by method of manufacturing metal air cells described herein. This method includes a thermoset molding step to integrate the cell structure with necessary cell components. This method offers reliable, stable structure and, most importantly, good bonding with porous components (e.g., air cathode, charging cathode) to prevent potential leakage. The above-discussed and other features and advantages of the present invention will be appreciated and understood by those skilled in the art from the following detailed description and drawings.

### BRIEF DESCRIPTION OF THE DRAWINGS

FIG. 1 illustrates a typical metal air cell;

FIG. 2 illustrates a typical refuelable metal air cell;

### DETAILED DESCRIPTION OF THE ILLUSTRATIVE EMBODIMENTS

A metal air cell includes an anode and the cathode. An electrolyte is disposed between the cathode and the anode, the electrolyte provided within the anode, separately at the interface between the cathode and the anode, or both within the anode and separately at the interface between the cathode and the anode.

Referring now to the drawings, an illustrative embodiment of the present invention will be described. For clarity of the description, like features shown in the figures shall be indicated with like reference numerals and similar features as shown in alternative embodiments shall be indicated with similar reference numerals.

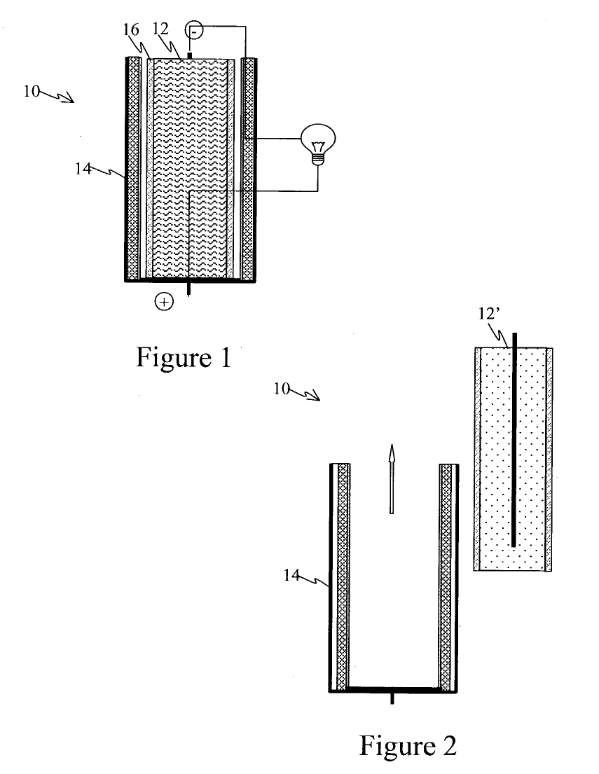

Referring now to FIG. 1, a metal air electrochemical cell 10 of a generally prismatic configuration is depicted. The cell 10 includes an anode structure 12 within an essentially U-shaped housing 14 holding a pair of active air diffusion electrode portions, and capable of holding a quantity of liquid electrolyte. The anode structure 12 and the active cathode portions are maintained in electrical isolation and ionic communication through a separator 16, described further herein.

Oxygen from the air or another source is used as the reactant for the air cathode of the metal air cell 10. When oxygen reaches the reaction sites within the air diffusion electrode, it is converted into hydroxyl ions together with water. At the same time, electrons are released to flow as electricity in the external circuit. The hydroxyl travels through electrolyte to reach the metal fuel material of the anode 12. When hydroxyl reaches the metal anode (in the case of an anode 12 comprising, for example, zinc), zinc hydroxide is formed on the surface of the zinc. Zinc hydroxide decomposes to zinc oxide and releases water back to the alkaline solution. The reaction is thus completed.

The anode reaction is:

Zn+4OH⁻→Zn(OH)²+2e (1)

Zn(OH)₄²→ZnO+H₂O+2OH⁻ (2)

The cathode reaction is:

½O₂+H₂O+2e→2OH⁻ (3)

Thus, the overall cell reaction is:

Zn+% ½O₂→ZnO (4)

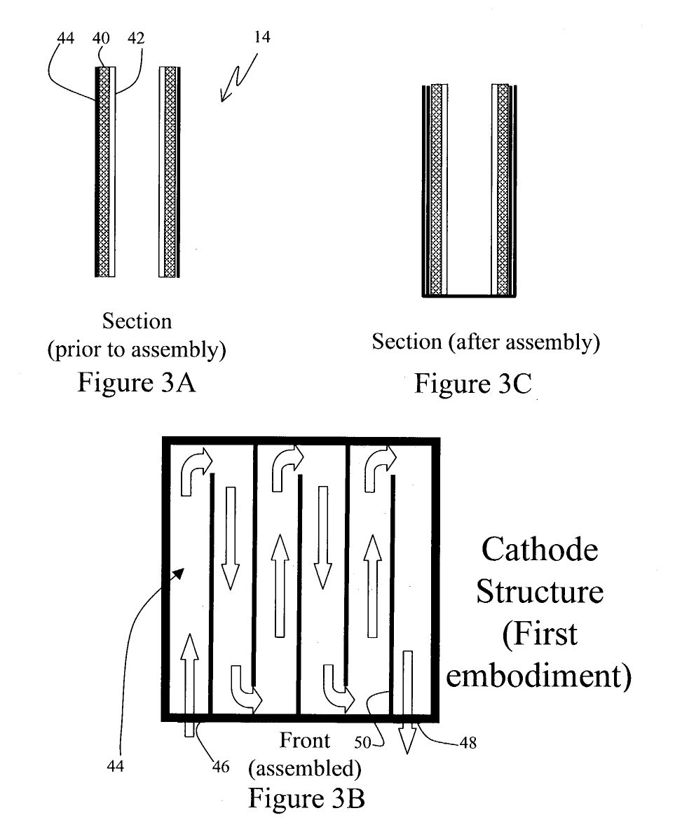

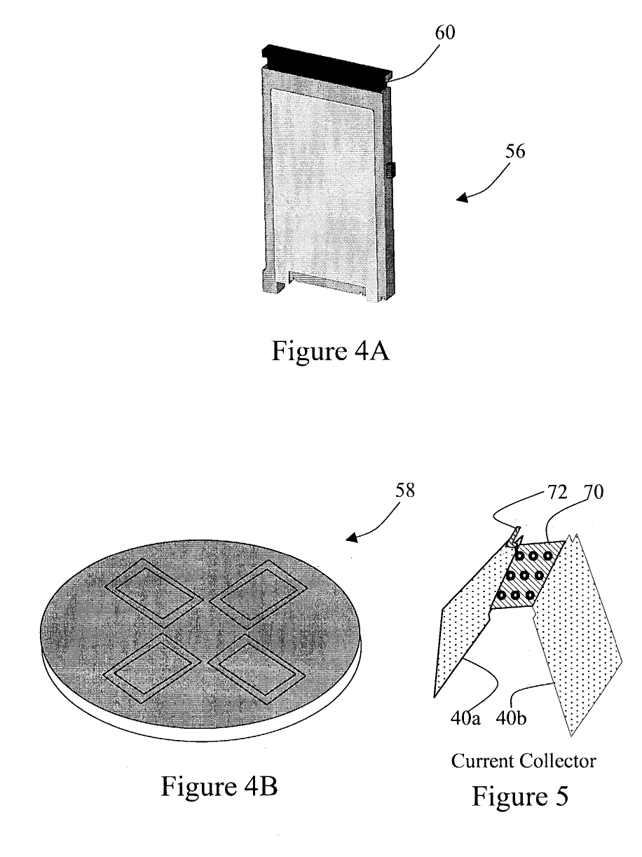

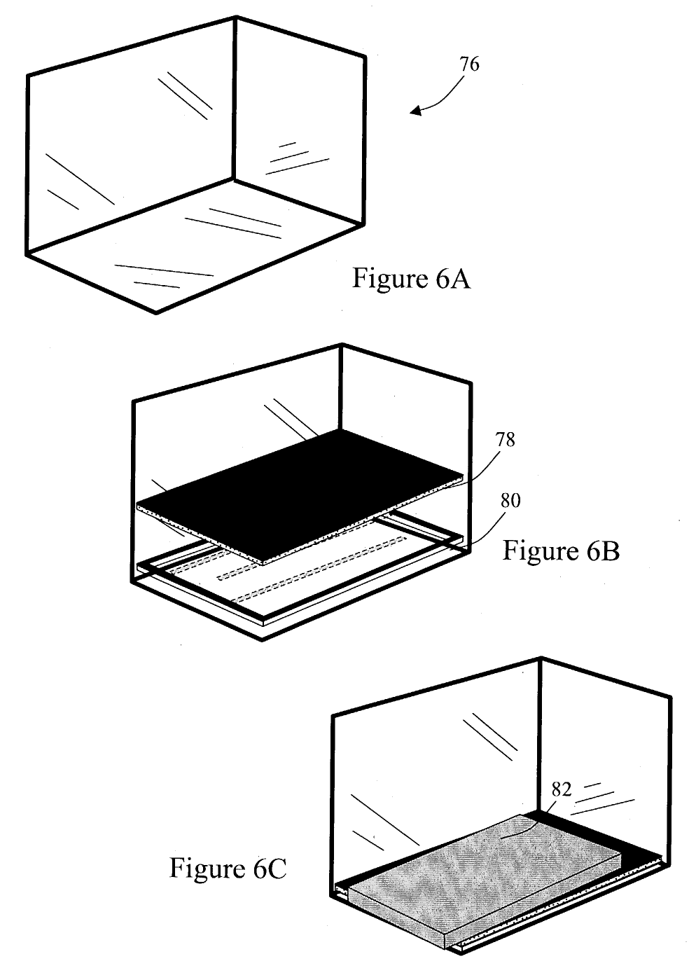

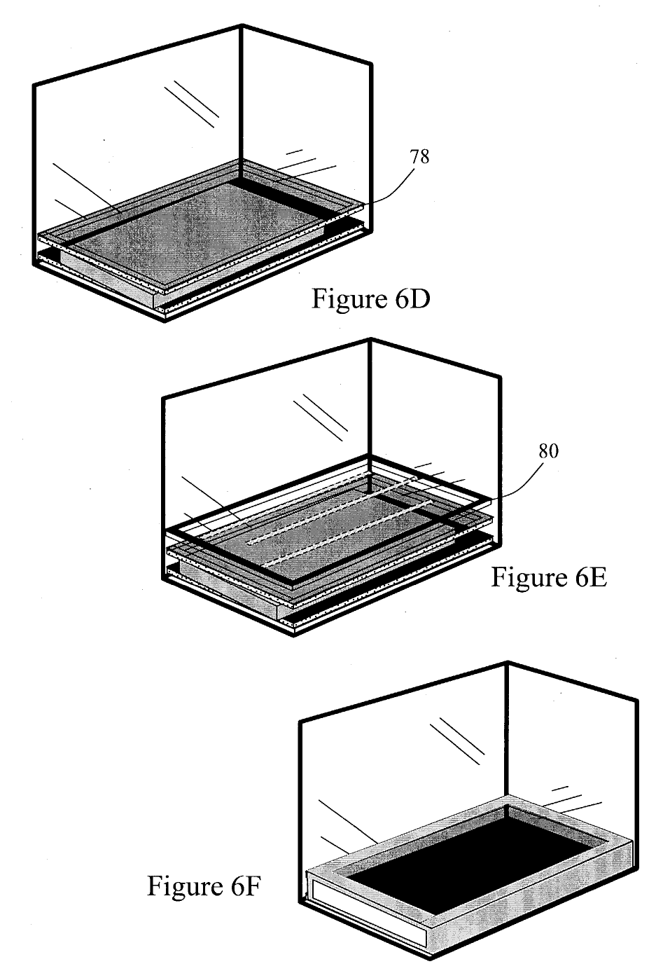

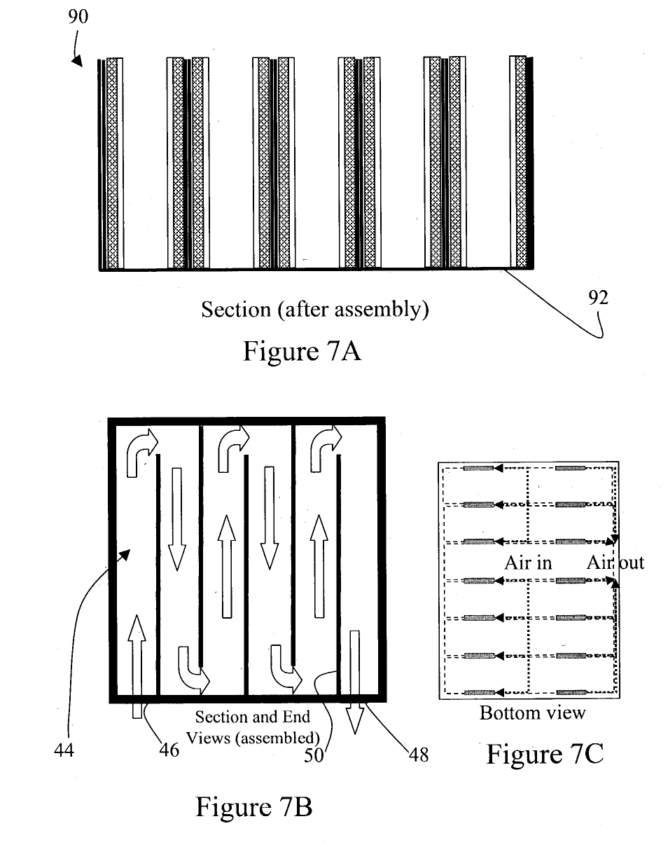

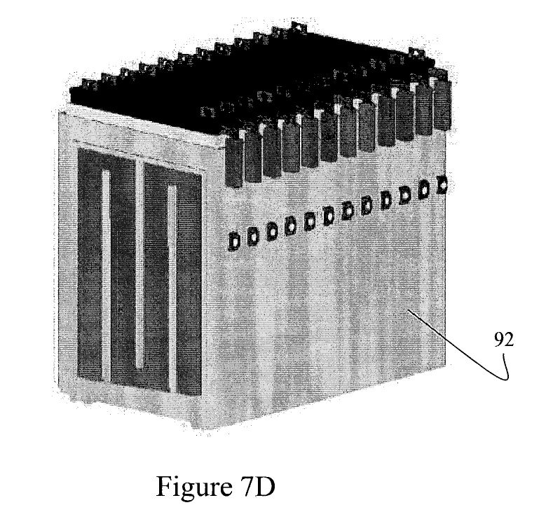

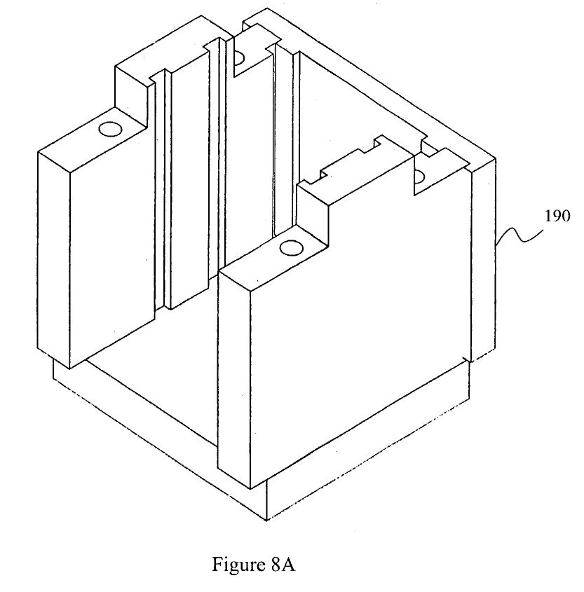

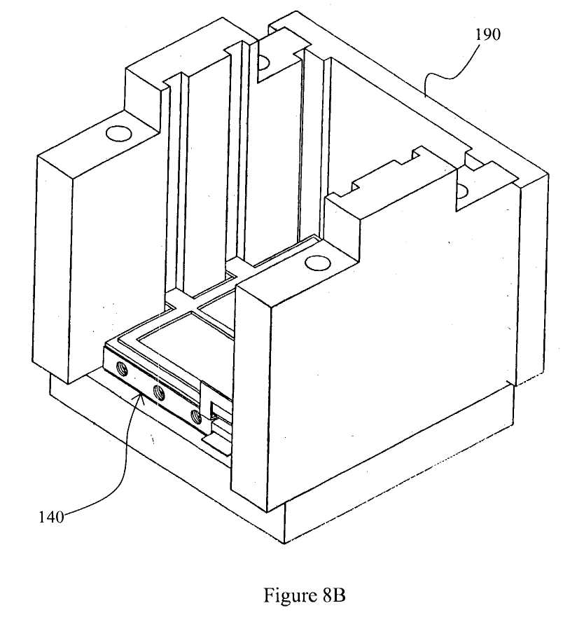

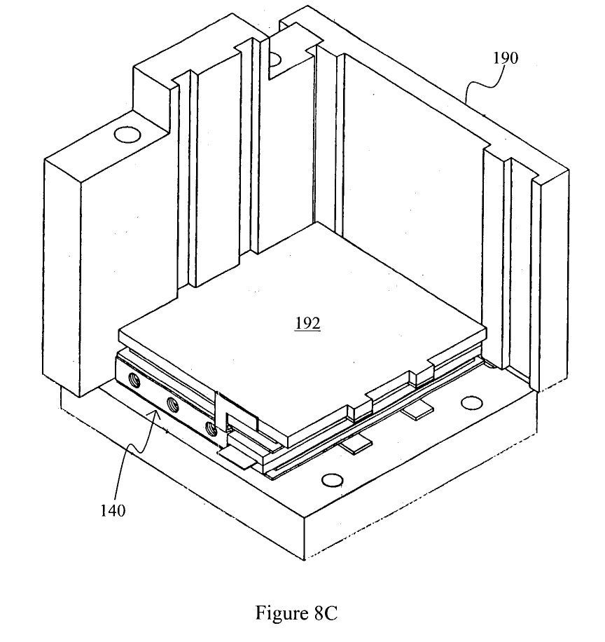

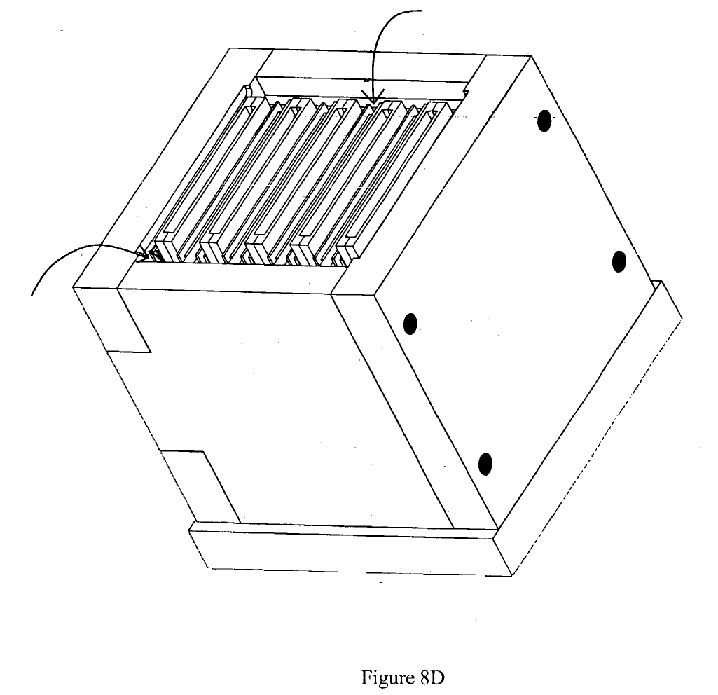

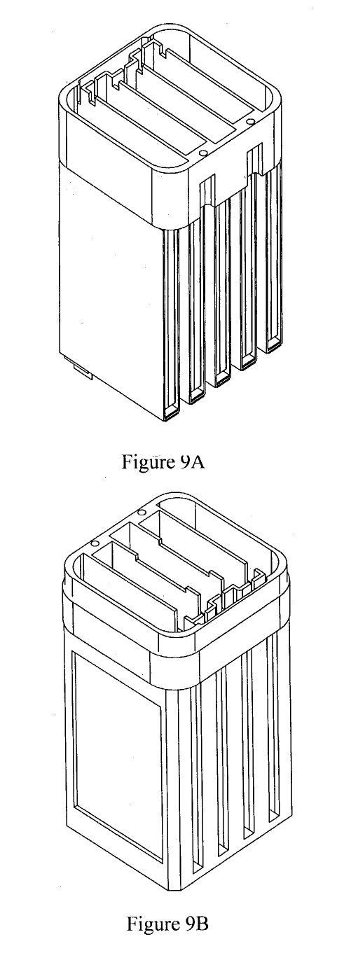

Referring now to FIG. 2, removal of an anode 12′, which has had essentially all of the consumable fuel therein converted to a metal oxide as generally described above in reactions (1) through (4), is shown.

In either general structure of FIG. 1 or 2, liquid electrolyte may be used in the system, and is contained within the housing 14. Thus, it is important that the housing 14 be stable and essentially leak proof. As mentioned above, the attachment between the air diffusion electrode and the walls or surfaces of the housing is a source of leakage. Structures made according to the methods described herein provide the requisite sealing to prevent electrolyte leakage.

The anode structure 12 generally includes a consumable anode portion surrounded on its two opposing major faces with a separator, a current collector and optionally a frame structure.

The consumable anode portion may be pressed, sintered, or otherwise formed into the desired shape (e.g., prismatic as shown in the figures). Alternatively anode structure may comprise an anode grid structure loaded with anode material, for example as described in U.S. patent application Ser. No. 10/074,893 entitled “Metal Air Cell System” filed on Feb. 11, 2002, incorporated by reference herein. In an alternative embodiment, at least a portion of the electrolyte used in the cell is embedded into the porous structure of the consumable anode portion. The separator would therefore be disposed between the anode and cathode for electrical isolation. The separator is shown as disposed the surface of the anode; however, the separator may alternatively be disposed on only the cathode (e.g., wherein the consumable anode portion is formed as to minimize migration through the rigid structure), or both the anode and cathode.

Anode portion generally comprises a metal constituent such as metal and/or metal oxides and the current collector. Optionally an ionic conducting medium is provided within each anode portion. Further, in certain embodiments, anode portion comprises a binder and/or suitable additives. Preferably, the formulation optimizes ion conduction rate, capacity, density, and overall depth of discharge, while minimizing shape change during cycling.

The metal constituent may comprise mainly metals and metal compounds such as zinc, calcium, lithium, magnesium, ferrous metals, aluminum, oxides of at least one of the foregoing metals, or combinations and alloys comprising at least one of the foregoing metals. These metals may also be mixed or alloyed with constituents including, but not limited to, bismuth, calcium, magnesium, aluminum, indium, lead, mercury, gallium, tin, cadmium, germanium, antimony, selenium, thallium, oxides of at least one of the foregoing metals, or combinations comprising at least one of the foregoing constituents. The metal constituent may be provided in the form of powder, fibers, dust, granules, flakes, needles, pellets, or other particles. In certain preferred embodiments, fibrous metal, particularly zinc fiber material, is provided as the metal constituent. During conversion in the electrochemical process, the metal is generally converted to a metal oxide. In preferred embodiments where the metal is in fiber form, the porosity or void volume of the mass of anode material is maximized as compared to granule zinc; accordingly, detriments typically associated with the inherent anode expansion during conversion are minimized, as expanded zinc oxide may be accumulated in the void regions.

The anode current collector may be any electrically conductive material capable of providing electrical conductivity. The current collector may be formed of various electrically conductive materials including, but not limited to, copper, brass, ferrous metals such as stainless steel, nickel, carbon, electrically conducting polymer, electrically conducting ceramic, other electrically conducting materials that are stable in alkaline environments and do not corrode the electrode, or combinations and alloys comprising at least one of the foregoing materials. The current collector may be in the form of a mesh, porous plate, metal foam, strip, wire, plate, or other suitable structure. To facilitate connection of plural cells 10, anode current collectors may be conductively attached (e.g., welded, riveted, bolted, or a combination thereof to a common bus, connecting the cells in series, parallel, or combination series/parallel, as is conventionally known.

An electrolyte or ionic conducting medium is provided in the cell 10, generally comprising alkaline media to provide a path for hydroxyl to reach the metal and metal compounds. The ionically conducting medium may be in the form of a bath, wherein a liquid electrolyte solution is suitably contained. In certain embodiments, an ion conducting amount of electrolyte is provided in anode 12, as described above. The electrolyte generally comprises ionic conducting materials such as KOH, NaOH, LiOH, other materials, or a combination comprising at least one of the foregoing electrolyte media. Particularly, the electrolyte may comprise aqueous electrolytes having a concentration of about 5% ionic conducting materials to about 55% ionic conducting materials, preferably about 10% ionic conducting materials to about 50% ionic conducting materials, and more preferably about 30% ionic conducting materials to about 45% ionic conducting materials. Other electrolytes may instead be used, however, depending on the capabilities thereof, as will be obvious to those of skill in the art.

The cathode generally requires an active constituent and a diluent, along with suitable connecting structures, such as a current collector. The cathode may optionally comprise a protective layer (e.g., polytetrafluoroethylene commercially available under the trade name Teflon® from E. I. du Pont Nemours and Company Corp., Wilmington, Del.) on the side exposed to air. The cathode materials including the protective layer (optional), the active cathode surface, and the diluent may be any suitable material as is known to those skilled in the art. Generally, the cathode catalyst is selected to attain current densities (in ambient air) of at least 20 milliamperes per squared centimeter (mA/cm²), preferably at least 50 mA/cm², and more preferably at least 100 mA/cm². Higher current densities may be attained with suitable cathode catalysts and formulations and with use of higher oxygen concentrations, such as substantially pure air.

The oxygen supplied to the cathode portions may be from any oxygen source, such as air; scrubbed air; pure or substantially oxygen, such as from a utility or system supply or from on site oxygen manufacture; any other processed air; or any combination comprising at least one of the foregoing oxygen sources.

Cathode portions may be conventional air diffusion cathodes, for example generally comprising an active constituent and a carbon substrate, along with suitable connecting structures, such as a current collector. Typically, the cathode catalyst is selected to attain current densities in ambient air of at least 20 milliamperes per squared centimeter (mA/cm2), preferably at least 50 mA/cm2, and more preferably at least 100 mA/cm2. Of course, higher current densities may be attained with suitable cathode catalysts and formulations. The cathode may be a bi-functional, for example, which is capable of both operating during discharging and recharging. However, utilizing the systems described herein, the need for a bi-functional cathode is obviated, since the third electrode serves as the charging electrode.

The carbon used is preferably be chemically inert to the electrochemical cell environment and may be provided in various forms including, but not limited to, carbon flake, graphite, other high surface area carbon materials, or combinations comprising at least one of the foregoing carbon forms.

The cathode current collector may be any electrically conductive material capable of providing electrical conductivity and preferably chemically stable in alkaline solutions, which optionally is capable of providing support to the cathode portions 10. The current collector may be in the form of a mesh, porous plate, metal foam, strip, wire, plate, or other suitable structure. The current collector is generally porous to minimize oxygen flow obstruction. The current collector may be formed of various electrically conductive materials including, but not limited to, copper, ferrous metals such as stainless steel, nickel, chromium, titanium, and the like, and combinations and alloys comprising at least one of the foregoing materials. Suitable current collectors include porous metal such as nickel foam metal.

A binder is also typically used in the cathode, which may be any material that adheres substrate materials, the current collector, and the catalyst to form a suitable structure. The binder is generally provided in an amount suitable for adhesive purposes of the carbon, catalyst, and/or current collector. This material is preferably chemically inert to the electrochemical environment. In certain embodiments, the binder material also has hydrophobic characteristics. Appropriate binder materials include polymers and copolymers based on polytetrafluoroethylene (e.g., Teflon® and Teflon® T-30 commercially available from E. I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

The active constituent is generally a suitable catalyst material to facilitate oxygen reaction at the cathode. The catalyst material is generally provided in an effective amount to facilitate oxygen reaction at the cathode. Suitable catalyst materials include, but are not limited to: manganese, lanthanum, strontium, cobalt, platinum, and combinations and oxides comprising at least one of the foregoing catalyst materials.

An exemplary air cathode is disclosed in copending, commonly assigned U.S. Pat. No. 6,368,751, entitled “Electrochemical Electrode For Fuel Cell”, to Wayne Yao and Tsepin Tsai, which is incorporated herein by reference in its entirety. Other air cathodes may instead be used, however, depending on the performance capabilities thereof, as will be obvious to those of skill in the art.

To electrically isolate the anode from the cathode, a separator is provided between the electrodes, as is known in the art. The separator may be any commercially available separator capable of electrically isolating the anode and the cathode, while allowing sufficient ionic transport therebetween. Preferably, the separator is flexible, to accommodate electrochemical expansion and contraction of the cell components, and chemically inert to the cell chemicals. Suitable separators are provided in forms including, but not limited to, woven, non-woven, porous (such as microporous or nanoporous), cellular, polymer sheets, and the like. Materials for the separator include, but are not limited to, polyolefin (e.g., Gelgard® commercially available from Dow Chemical Company), polyvinyl alcohol (PVA), cellulose (e.g., nitrocellulose, cellulose acetate, and the like), polyethylene, polyamide (e.g., nylon), fluorocarbon-type resins (e.g., the Nafion® family of resins which have sulfonic acid group functionality, commercially available from du Pont), cellophane, filter paper, and combinations comprising at least one of the foregoing materials. The separator 16 may also comprise additives and/or coatings such as acrylic compounds and the like to make them more wettable and permeable to the electrolyte.

Embodiments of conductive membranes suitable as a separator are described in greater detail in: U.S. patent application Ser. No. 09/259,068, entitled “Solid Gel Membrane”, by Muguo Chen, Tsepin Tsai, Wayne Yao, Yuen-Ming Chang, Lin-Feng Li, and Tom Karen, filed on Feb. 26, 1999; U.S. Pat. No. 6,358,651 entitled “Solid Gel Membrane Separator in Rechargeable Electrochemical Cells”, by Muguo Chen, Tsepin Tsai and Lin-Feng Li, filed Jan. 11, 2000; U.S. Ser. No. 09/943,053 entitled “Polymer Matrix Material”, by Robert Callahan, Mark Stevens and Muguo Chen, filed on Aug. 30, 2001; and U.S. Ser. No. 09/942,887 entitled “Electrochemical Cell Incorporating Polymer Matrix Material”, by Robert Callahan, Mark Stevens and Muguo Chen, filed on Aug. 30, 2001; all of which are incorporated by reference herein in their entireties.

Referring now to FIGS. 3A-3C, an embodiment of an air diffusion structure, particularly, embedded within a housing 14, formed according to the invention herein, is depicted. The housing 14 includes an active cathode portion 40 and an optional separator 42 adjacent thereto (facing toward the center of the housing 14 intended to form an electrochemical cell with a metal negative electrode). Note that the separator may be obviated depending on the chosen electrolyte scheme and anode structure. A current collector may also be formed, an example of which is described further herein. Further, the housing 14 optionally includes air frames 44 positioned adjacent the active cathode portion 40 for assisting in distributed air flow across the surface of the cathode portion 40. With the optional air frames 44, and referring now to FIG. 3B, air enters generally via an inlet 46 of the air frame 44 and exits via an outlet 48, traversing in generally a serpentine manner across the face of the cathode portion 14 due to the barriers 50. An individual cell may be assembled (FIG. 3C), for example, by thermoset molding (e.g., pour casting or reactive injection molding) a non-conductive frame structure 52 about the cell components.

Particularly, one method of manufacture includes spin casting the frame for the cathode structure, to both form the frame and to integrate the cathode portions 40 and the air frames 44. Each spin casting process commences with a mold preparation. Aluminum masters may be designed and fabricated to create a cavity in a silicone mold. FIG. 4A shows an exemplary mold master 56. The mold may be set, for example, by heating up the raw silicone materials together with the master mold to a high temperature (˜450 ° C.) for more than 2 hours. Once the mold is created, it is ready for spin casting cathode together with casting materials. As shown in FIG. 4B, an exemplary mold 58 (e.g., half of the total mold system) is shown capable of spin casting 4 cells simultaneously, however it is understood that fewer or more cell cavities may be formed in a single mold.

Active cathode material may be formed or cut to the desired size (e.g., the size assumption used in the master). In certain embodiments, a single portion is used to form both sides of the structure in FIGS. 3A and 3B. In other embodiments, separate portions may be used.

A current collector may be attached to the one or more cathode portions, for example, with brass rivets. One preferred configuration is depicted in FIG. 5. As shown, a single cathode strip may be used to form a pair of cathode portions 40a and 40b. A current collector 70 may be riveted or otherwise secured centrally on the strip dividing it into the pair of cathode portions 40a and 40b. To facilitate electrical contact, a tab 72 is provided.

The active cathode then may be wrapped around a non-stick plastic core 60. This plastic core 60 is used to create the cell cavity for the electrolyte and the anode. Then, on the outside of the cathode portion (one or both, depending on the desired use of the cell), a plastic frame 44 is optionally inserted into the mold to create the serpentine air management structure. After all parts were assembled together, the assemblies then may be loaded into a spin casting machine as in known in the art of spin casting, and opposite mold halves are closed together.

Suitable materials for casting or reaction injecting to mold the structure include caustic resistant materials. In particular, monomers or polymer blends may be selected for in situ polymerization, thereby allowing polymerization and possibly cross-linking within, for example, the pores of the cathode to form a tight seal, thereby illuminating electrolyte leakage from the edges of the naturally porous cathode, and providing structural binding and support for all of the cell components. A preferred type of material includes polyurethane, such as TEK plastic polyurethane (TAN) commercially available from Tekcast Industries, Inc. New Rochelle N.Y. (manufactured by Alumilite Corporation, Kalamazoo Mich.).

During the spin casting process, the whole mold is spun at a certain speed to create centrifugal force for transferring casting materials. After casting material is poured into the center of the mold, it flows into the entire cavity to form the cell frame, and at the same time to seal the edges of the active cathode portions. The casting materials are then allowed to solidify (e.g., 10-15 minutes for urethane based starting materials).

Advantages of this method included the elimination of conventional cathode gluing processed. Air diffusion cathodes, which are generally porous, are now fully sealed at the edges that have been cured with casting materials (e.g., polyurethane). Particularly, since the casting materials polymerized and cross-links in-situ, a very strong bond and liquid seal is formed, thus also preventing electrolyte leakage. Further, corrosion prone parts, such as the current collector, may be completely or partially covered and sealed to prevent or minimize corrosion by caustic electrolyte (e.g., KOH).

FIGS. 6A-6F show steps in another method of making a cell having a porous gas diffusion electrode is shown, the method including pour casting or reaction injection molding of the casting materials. Referring now to FIG. 6A, a portion of a mold 76 that may be used for pour casting or reaction injection molding is shown. As shown in FIG. 6B, The mold 76 may be loaded with active cathode material 78, and an optional air frame portion 80, formed or inserted with suitable inserts to maintain an opening for the air side of the air diffusion electrode. Referring now to FIG. 6C, an anode blank 82 is loaded and positioned atop the cathode material 78. Alternatively, if the cathode structure of FIG. 5 is used, the blank 82 may be inserted between the sections of the electrode. Suitable spacers (e.g., that may remain part of the final structure) may be provided to maintain the size of the anode space after casting. Referring now to FIG. 6D, another air diffusion electrode portion 78 is shown. FIG. 6E shows another optional air cathode frame 80. The parts are stacked until a suitable number of cells are formed. Thereafter, the mold 76 may be closed on all sides, leaving an opening for reaction injection molding. Alternatively, a top side may be excluded, whereby the casting material is introduced by pour casting. In either casting or molding technique, the casting material is allowed to polymerize and cross-links in-situ. FIG. 6F shows a single cell cast according to the method of FIGS. 6A-6E. In particular, since the casting materials are allowed to polymerize and cross-links in-situ, a very strong bond and liquid seal is formed, thus also preventing electrolyte leakage. Further, corrosion prone parts, such as the current collector, may be completely or partially covered and sealed to prevent or minimize corrosion by caustic electrolyte (e.g., KOH).

Referring now to FIGS. 7A-7D, an assembly 90 of plural housings 14 is depicted. Inlets and outlets of cathode air frames of adjacent housings 14 are aligned (FIG. 6C), and the barriers 50 of the adjacent air frames preferably form a common serpentine air distribution system (FIG. 7B) across adjacent cathode portions. The entire assembly 90 may be introduced in a suitable mold (e.g., described with respect to FIGS. 6A-6E) with appropriate spacers to allow openings for the air channel and for the anode region, and pour cast or reaction injection molded. After allowing the cast material to polymerize, particularity polymerize and cross-link in situ at the edges of the air diffusion electrodes, a structurally sound and leakage resistant system is formed.

The assembly shown with respect to FIG. 7D may be one that is refuelable, as described generally above with respect to FIG. 2. In further embodiments, an electrolyte management system may be provided, wherein the cast shell 92 may include suitable electrolyte management structures, as described in PCT Application No. PCT/US02/30585 entitled “Rechargeable and Refuelable Metal Air Electrochemical Cell” filed on Sep. 26, 2002, which is incorporated by reference herein. One of skill in the art will recognize that suitable plates or other molding structures are included with the cell structures to provide air passages between the cells, and centrally in the cell structures to form a pocket for electrolyte and the anode assembly.

Referring now to FIGS. 8A-8D, another embodiment of a method for casting a unitary structure from a plurality of cells are shown. FIG. 8A shows a portion of a mold 190 configured for receiving a plurality of individual cells 140. Each cell 140 generally includes a pair of opposing air diffusion electrodes (or an integral structure as described above with respect to FIG. 5) and a blank anode placeholder therebetween (not shown). Referring now to FIG. 8B, one cell structure 140 is placed in the mold 190. Note that protrusions on the cell frame may be aligned with corresponding grooves on the inside wall of the molds 190. Referring now to FIG. 8C, wherein one wall of the mold 190 is removed in the Figure for clarity, a spacer 192 is provided adjacent to structure 140. The spacer 192 allows for airflow to access the air diffusion electrodes during usage after casting. Further, the spacer covers the main air access portion of the air diffusion electrode, while leaving exposed the outer edge portions of the air diffusion electrode portions. Referring now to FIG. 8D, a plurality of structures 140 are assembled within the molds 190. Once component structures 140 with spacers 192 are assembled the molds 190 is closed on all sides except for the surface opposite the terminals. Accordingly, prior to full assembly of the mold 190, the terminals are soldered or otherwise electrically connecting as desired. The molds 190 may be cast pour casting, spin casting, or reaction injection casting as described herein.

As indicating in FIG. 8D with a pair of arrows, various locations for pour casting materials are available. Accordingly, the five individual cells may be pour casted into an integral battery structure, minimizing or eliminating leakage, and further insulating the conductive terminals of the cells.

In another embodiment shown with respect to FIGS. 9A and 9B, a mold may be configured and dimensioned (not shown) to hold a reservoir structure. Thus, during casting of the cells, the reservoir structure may be integrally cast with the dry cell components. Referring to FIG. 9A, components of a metal air cell, and a reservoir structure (e.g., for holding and/or mixing electrolyte) are shown prior to casting. FIG. 9B shows a cell after casting, e.g. with a mold as described with respect to FIGS. 8A-8D. Such systems are described, for example, in PCT Application No. PCT/US03/00473 entitled “Reserve Battery” filed on Jan. 8, 2003, which is incorpoarted by reference herein.

One skilled in the art will recognize that various modifications are of the present invention are possible and intended to be within the scope of the herein attached claims. For example, suitable electrical connections may be incorporated before or after casting. In addition, a base structure may be provided, for example, to provide air management, offer mechanical strength, or both, before or after casting.

Benefits of the invention include formation of a structurally sound and leak resistant cell or cell system housing. By virtue of the cast material(s) polymerizing in situ, particularly at the edges of the air diffusion electrode structures, leak resistant cathode seals are provided, unattainable by prior art methods of attaching air diffusion electrodes to cell housings.

Furthermore, conventional injection molding techniques, that generally rely on thermoplastic rather than thermoset materials, may not be suitable for the above described edge sealing methods. First, caustic resistant injection molding material (e.g., ABS plastic) is prone to shrinkage, which may lead to undesirable cell and/or electrode deformation. Further, high pressures required with injection molding techniques, generally both in the form of clamping pressures to secure the mold, and injection pressures to inject the material. Typical injection molding processes require 10 to 100 M Pa, and even as low as 0.2-0.8 M Pa for specialty ceramic injection molding techniques. Such pressures may adversely affect the components themselves and the arrangement of the loose parts (since many of the parts used are not secured during the molding process). Additionally, injection molding techniques typically require temperatures of at least 200 degrees C., which will substantially detriment the electrodes and certain plastic frame components (e.g., the air frame). Accordingly, by using the casting techniques described herein (pour casting or spin casting), or using the “reaction injection molding”, with thermoset materials, temperatures and pressures may be minimized and the detriments associated with conventional high temperature and pressure injection molding are eliminated. With the herein described casting techniques (pour casting or spin casting), or using the “reaction injection molding”, temperatures and pressures may be on the order of ambient, which provides significant cost advantage to cell and cell system manufacture.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. A method of forming a metal air cell frame comprising:
molding a housing integrating periphery edges of an air diffusion electrode.

2. A method of forming a metal air cell frame comprising:
providing a mold configured for supporting an air diffusion electrode and configured for
providing a space for an anode and an ionic conducting medium;
inserting the air diffusion electrode in the mold;
inserting a spacer for the space for the anode; and
introducing frame constituent material into the mold to produce the metal air cell frame.

3. The method as in claim 2, further wherein mold is configured for supporting an air frame portion proximate the cathode element.

4. The method as in claim 2, wherein frame constituent material seals edges of the cathode element.

5. The method as in claim 2, wherein frame constituent material comprises urethane which polymerizes in to polyurethane.

6. The method as in claim 5, wherein the polyurethane polymerizes in situ at edges of the cathode element.

7. The method as in claim 2, further wherein mold is configured for supporting a cathode current collector

8. The method as in claim 2, wherein mold is configured for pour casting.

9. The method as in claim 2, wherein mold is configured for reaction injection molding.

10. The method as in claim 1 or 2, wherein casting is at ambient temperatures and pressures.
